(19) United States
(12) Patent Application Publication
(10) Pub. No.: US 2013/0303029 A1
(43) Pub. Date: Nov. 14, 2013

(54) ELECTRICAL CONNECTOR AND ELECTRICAL CONNECTOR HAVING A STRIP

(71) Applicant: ACTHERM INC, Hsinchu City (TW)

(72) Inventors: Min-Ying CHEN, Hukou Township (TW); Ching-Tai TSENG, Beidou Township (TW)

(73) Assignee: ACTHERM INC, Hsinchu City (TW)

(21) Appl. No.: 13/867,749

(22) Filed: Apr. 22, 2013

(30) Foreign Application Priority Data
May 8, 2012 (TW) 101116425

(51) Int. Cl. H01R 24/62

(52) U.S. Cl. CPC H01R 24/62
USPC 439/630; 439/676

(57) ABSTRACT

An electrical connector includes a base, a skid base, a housing and an electrode. The base is formed with a first inclined plane. The skid base is formed with a second inclined plane opposing the first inclined plane, where the second inclined plane is disposed on the first inclined plane in a slidable manner. The skid base is formed with a load plane opposite to the second inclined plane, and an inclined angle is between the load plane and a first inclined plane. The housing and the base are assembled with each other to accommodate the skid base in the housing. Opposing sides of the housing are formed with an insertion port, respectively, allowing an electrode and a strip to be inserted and connected to the electrical connector.

### BACKGROUND OF THE INVENTION

1. Technical Field

The present invention relates to an electrical connector, and in particular to an electrical connector for transmitting chemical or physical characteristics of materials being examined.

2. Description of the Prior Art

Medically, in order to attain the physical condition of a human, blood tests are often used for finding out causes of disease. Currently available blood tests include the following categories. Hematological test are used for attaining the functions and amount of blood cells and plasma, and thus for diagnosing anemia or leukemia. Biochemical tests are used for attaining the components of plasma, and thus they can be used for diagnosing diabetes or hyperlipidemia. Endocrinological tests are used for attaining whether endocrine organs are abnormal, and thus they can be used for diagnosing thyroid or suprarenal. Seralogical tests are used for attaining the performance of antigens and antibodies in blood serum, and thus they can be used for diagnosing virus infections or immunologic diseases. Drug concentration tests are used for attaining the amount of medicines and drugs in blood. Bacteriological tests are used for attaining pathogens causing infections. It can be understood that the abovementioned blood test have different objectives in screening, diagnosing, tracing, and prognosis assessing.

For testing instruments conventionally used only in hospitals, portable versions thereof have been developed with the improvement of technology. In addition, testing instruments with different functions have also been developed for different test requirements. Biochemical testing machines commonly used for testing physical conditions such as blood glucose are employed together with strips for in vitro tests, with the usage state thereof described as follows. First, an user inserts a strip into, usually, an electrical connector provided on a biochemical testing machine, such that an electrode end provided on the strip is connected with the electrical connector. Next, a specimen is dropped or dipped on a reaction end provided on the strip, then the biochemical testing machine starts the analysis of the specimen. After the test is finished, the strip is rejected out of the biochemical testing machine from the electrical connector. In the following, problems occur during the usage of the strip and electrical connector are discussed.

First, for electrical connectors without rejecting mechanism, it is necessary to pull out the strip after the tests. This will increase the chance of contacting body fluids, and therefore the user needs to be more cautious when pulling out the strip.

Then, for electrical connector with ejecting mechanism, the strip is ejected after use. The risk of spattering of body fluids or infection may be easily caused if the ejecting force is not properly controlled.

In cases of electrical connectors without rejecting mechanism or with ejecting mechanism, the inserting direction of the strip is often on the same horizontal plane as the rejecting direction thereof. Therefore, during the insertion and rejection of the strip, friction between the electrode end of the strip and the electrode is caused, so the electrode end is easy to be scratched or damaged by the electrode. As time passes, contact resistance between the electrode end and the electrode will increase, which further affect the accuracy of the biochemical testing machine.

In view of this, it is an important target for this industry to provide an electrical connector which prevents users from directly contacting body fluids and improves accuracy by lowering the contact resistance of the electrode.

### SUMMARY OF THE INVENTION

To solve the abovementioned defects of prior art, the present invention provides an electrical connector comprising a base, a skid base, a housing and electrodes, in which the base is formed with a first inclined plane, the first inclined plane has a first end and a second end, the first end is higher than the second end, and a first assembling section is formed on each side of the first inclined plane of the base. The skid base is disposed on the base and has a first side facing the first inclined plane formed with a second inclined plane, the second inclined plane has a first end and a second end, the first end is higher than the second end, the second inclined plane of the skid base is slidably disposed on the first inclined plane of the base, the skid base has a second side opposing the first side formed with a load plane, the first inclined plane extends at a first inclined angle to the downside of the load plane. The housing is disposed above the skid base and assembled with the base, the housing has a first side facing the load plane of the skid base formed with a recess, the skid base is accommodated between the recess of the housing and the first inclined plane of the base, a second assembling section is formed on each side of the housing to be correspondingly assembled with the first assembling section, the second assembling section of the housing and the first assembling section of the base are joined correspondingly, the housing has a side adjacent to the second assembling section formed with a first insertion port. The electrodes are inserted through another side adjacent to the second assembling section of the housing opposing the first insertion port of the housing.

Therefore, the first objective of the present invention is to provide an electrical connector having a strip, in which the second inclined plane of the skid base having an inclined angle and the first inclined plane of the base having the inclined angle contact each other, so the strip moves on the base smoothly due to the inclined angle of the skid base caused by height difference. Therefore, scratch or damage can be reduced when the electrodes contact the strip, and the contact impedance of the electrical connector can be lowered, thereby improving the accuracy of tests.

The second objective of the present invention is to provide an electrical connector having a strip, in which the skid base provides an ejecting mechanism for the electrical connector through the first ejecting blocks together with the first and second restriction planes. Thus, after a test, the strip can be ejected without using human hands, which reduces the possibility of contacting body fluids with human body.

The third objective of the present invention is to provide an electrical connector having a strip, in which the used strip is ejected after a test, wherein the retainment of the first ejecting blocks by the first and second restriction planes enables control of the force for ejecting the skid base, so that the risk of body fluid spattering and infection can be avoided.

The fourth objective of the present invention is to provide an electrical connector having a strip, in which the housing and second and first assembling sections of the base are detachably assembled for convenience of assembling and disassembling.

Further, the present invention provides an electrical connector having a strip comprising an electrical connector and a strip, in which the electrical connector comprises a base, a skid base, a housing and electrodes, in which the base is formed with a first inclined plane, the first inclined plane has a first end and a second end, the first end is higher than the second end, a first assembling section is formed on each side of the first inclined plane of the base. The skid base is disposed on the base and has a first side facing the first inclined plane formed with a second inclined plane, the second inclined plane has a first end and a second end, the first end is higher than the second end, the second inclined plane of the skid base is slidably disposed on the first inclined plane of the base, the skid base has a second side opposing the first side formed with a load plane, the first inclined plane extends at a first inclined angle to the downside of the load plane. The housing is disposed above the skid base and assembled with the base, the housing has a side facing the load plane of the skid base formed with a recess, the skid base is accommodated between the recess of the housing and the first inclined plane of the base, a second assembling section is formed on each side of the housing to be correspondingly assembled with the first assembling section, the second assembling section of the housing and the first assembling section of the base are joined correspondingly, the housing has a side adjacent to the second assembling section formed with a first insertion port. The electrodes are inserted through another side adjacent to the second assembling section of the housing to be opposite to the first insertion port of the housing. The strip has an electrode end, the electrode end of the strip is inserted through the first insertion port of the housing along an insertion direction, the electrode end is placed on the load plane of the skid base, the skid base is pushed by the electrode end to skid on the base along a displacement direction, the insertion direction and the displacement direction include a second inclined angle, and the second inclined angle is equal to the first inclined angle.

Therefore, the first objective of the present invention is to provide an electrical connector having a strip, in which the second inclined plane of the skid base has an inclined angle and the first inclined plane of base having the inclined angle contact each other. When inserting the strip, the insertion direction of the strip and the displacement direction of the skid base intersect and form an inclined angle, enabling the strip to move on the base smoothly due to the inclined angle of the skid base caused by height difference. Therefore, scratch or damage can be reduced when the electrodes contact the strip, and the contact impedance of the electrical connector can be lowered, thereby improving the accuracy of tests.

The second objective of the present invention is to provide an electrical connector having a strip, in which the skid base provides an ejecting mechanism for the electrical connector through the first ejecting blocks together with the first and second restriction planes. Thus, after a test, the strip can be ejected without using human hands, which reduces the possibility of contacting body fluids with human body.

The third objective of the present invention is to provide an electrical connector having a strip, in which the used strip is ejected after a test, wherein the retainment of the first ejecting blocks by the first and second restriction planes enables control of the force for ejecting the skid base, so that the risk of body fluid spattering and infection can be avoided.

The fourth objective of the present invention is to provide an electrical connector having a strip, in which the housing and second and first assembling sections of the base are detachably assembled for convenience of assembling and disassembling.

### BRIEF DESCRIPTION OF THE DRAWINGS

FIG. 1 is a perspective assembled view of an electrical connector according to an embodiment of the present invention.

FIG. 2 is a perspective exploded view of the electrical connector according to an embodiment of the present invention.

FIG. 3 is a perspective schematic view of a base according to an embodiment of the present invention.

FIG. 4a is a perspective schematic view of a skid base according to an embodiment of the present invention from a first viewpoint.

FIG. 4b is a perspective schematic view of the skid base according to an embodiment of the present invention from a second viewpoint.

FIG. 5a is a perspective schematic view of a housing according to an embodiment of the present invention from a first viewpoint.

FIG. 5b is a perspective schematic view of the housing according to an embodiment of the present invention from a second viewpoint.

FIG. 6a is a schematic plane view showing a height difference of a first inclined plane of the electrical connector according to an embodiment of the present invention.

FIG. 6b is a schematic plane view showing a height difference of a second inclined plane of the electrical connector according to an embodiment of the present invention.

FIG. 7a is a schematic plane view showing a height difference of a first restriction plane of the electrical connector according to an embodiment of the present invention.

FIG. 7b is a schematic plane view showing a height difference of a first ejecting block of the electrical connector according to an embodiment of the present invention.

FIG. 7c is a schematic plane view showing a height difference of a second restriction plane of the electrical connector according to an embodiment of the present invention.

FIG. 8a is a cross-sectional view showing an assembly of the base, skid base, housing and electrodes of the electrical connector according to an embodiment of the present invention.

FIG. 8b is a cross-sectional view schematically showing the assembly of the base, skid base, housing and electrode of the electrical connector and a first inclined angle according to an embodiment of the present invention.

FIG. 9 is a cross-sectional side view showing the assembly of the base, skid base, housing and electrode of the electrical connector according to an embodiment of the present invention.

FIG. 10 is a cross-sectional view schematically showing an assembly of the base, skid base, housing, electrode and a strip of the electrical connector and a second inclined angle according to an embodiment of the present invention.

FIG. 11a is a top view schematically showing the strip and skid base of the electrical connector and the insertion of the strip, according to an embodiment of the present invention.

FIG. 11b is a cross-sectional view schematically showing the strip and skid base of the electrical connector and the insertion of the strip, according to an embodiment of the present invention.

### DETAILED DESCRIPTION OF THE PREFERRED EMBODIMENTS

The present invention discloses an electrical connector and an electrical connector with strip. The electrical principles used by the electrical connector have been understood by those skilled in the art, and therefore will not be described in detail. Moreover, the drawings to which the following description refers are for illustrating structures regarding the features of the present invention, and are not drawn according to actual dimensions.

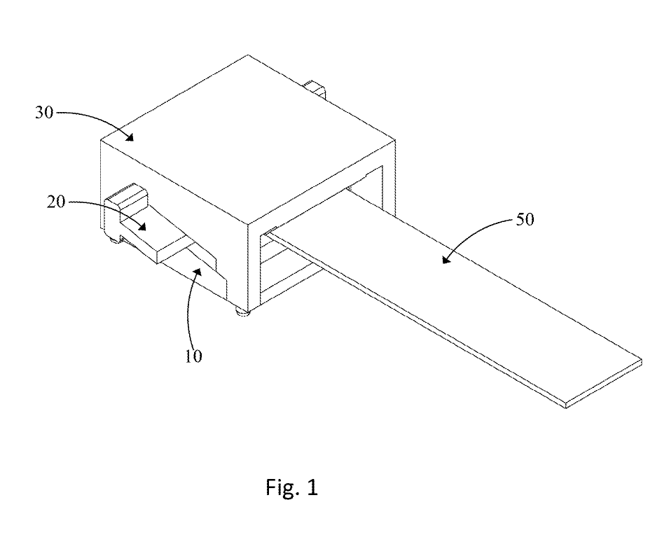

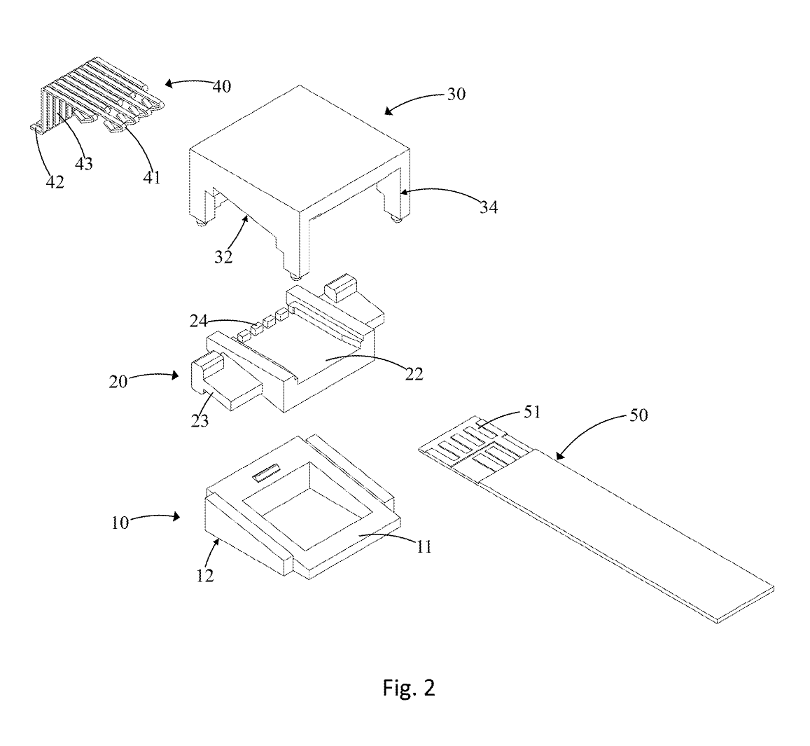

Please refer to FIG. 1 and FIG. 2. FIG. 1 is a perspective assembled view of an electrical connector, while FIG. 2 is a perspective exploded view of the electrical connector. The electrical connector of the present embodiment includes a base 10, a skid base 20, a housing 30 and a plurality of electrodes 40. The electrical connector may be used along with a strip 50, and may be disposed on a biochemical testing machine.

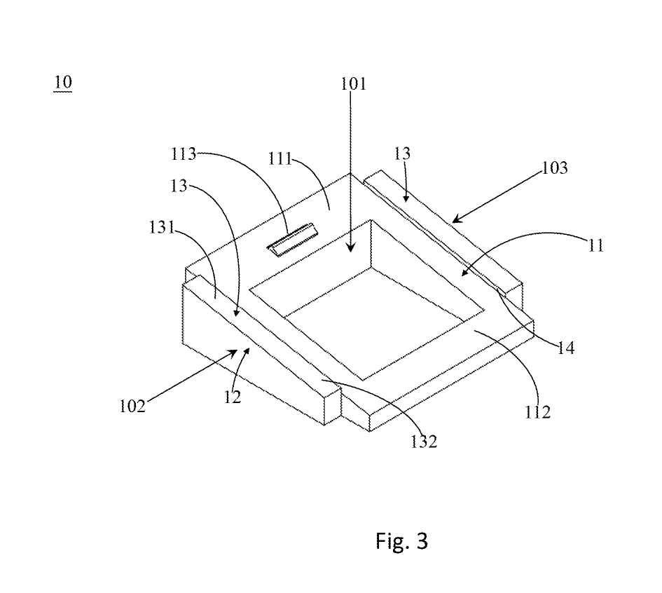

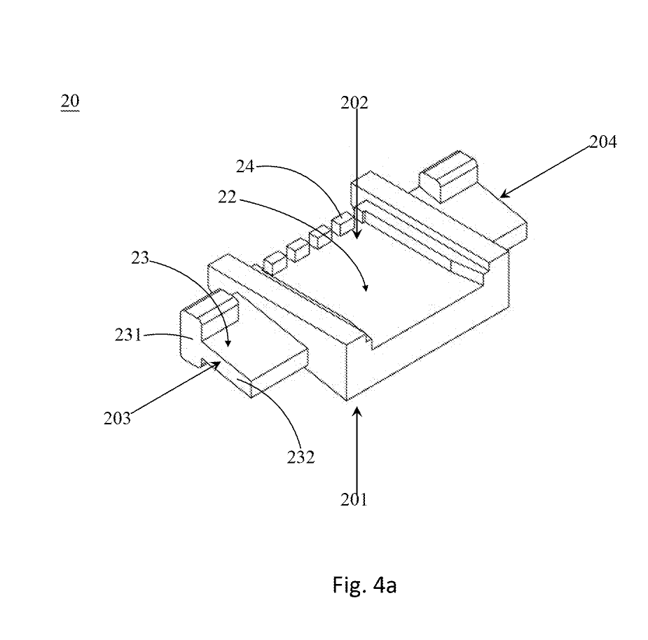

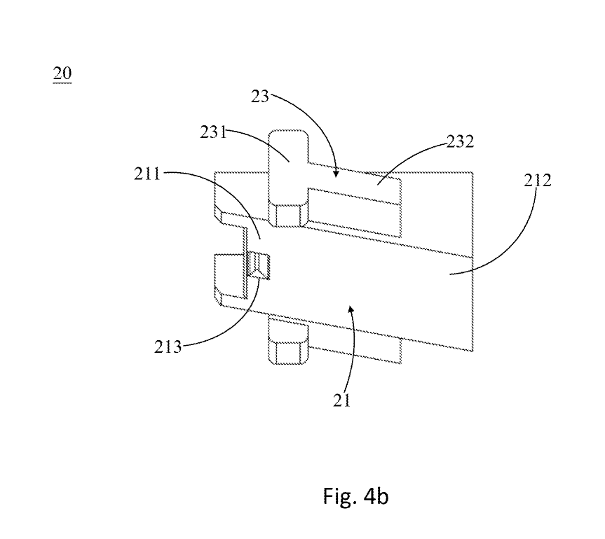

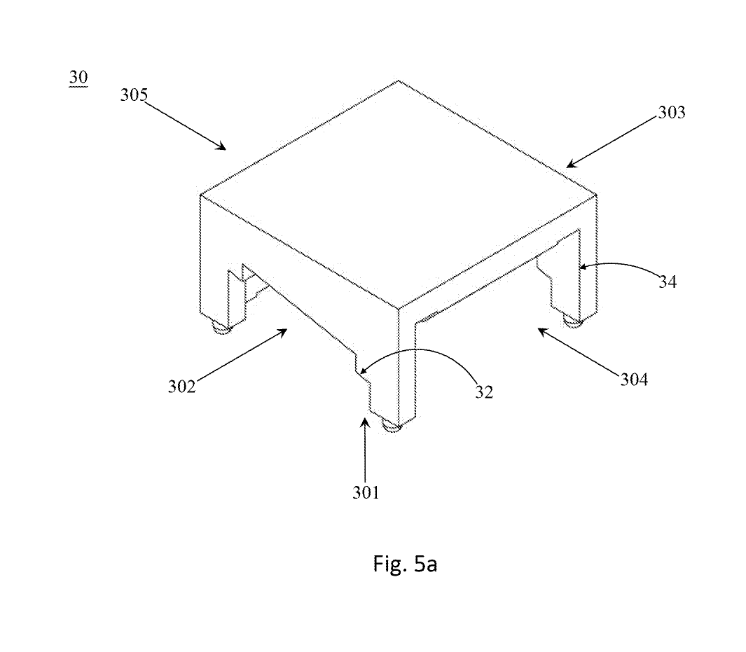

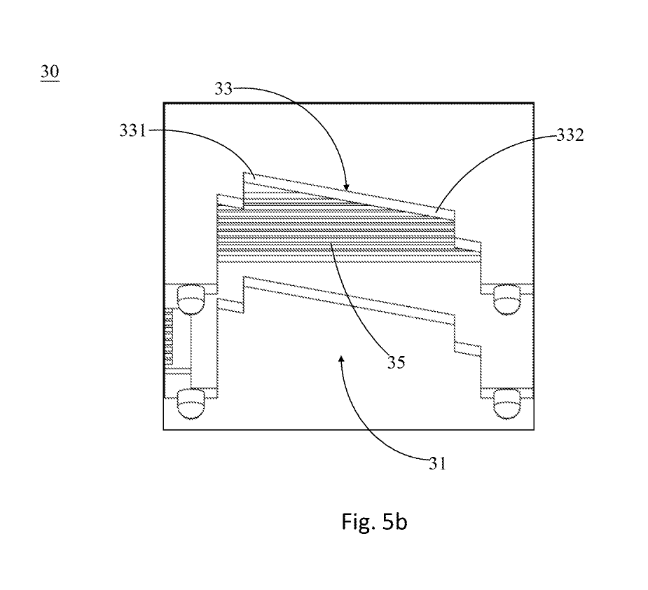

First refer to FIG. 3, FIG. 4a and FIG. 5a, in which respective portions of the major elements are defined. The portions of the base 10 (refer to FIG. 3, which is a perspective view of the base) are defined as follows: a first side 101, a second side 102 and a third side 103. The portions of the skid base 20 (refer to FIG. 4a, which is a perspective view of the skid base) are defined as follows: a first side 201, a second side 202, a third side 203 and a fourth side 204. The portions of the housing 30 (refer to FIG. 5a, which is a perspective view of the housing) are defined as follows: a first side 301, a second side 302, a third side 303, a fourth side 304 and a fifth side 305.

The detailed structure of the base 10, skid base 20, housing 30 and electrodes 40 are described below.

Refer to FIGS. 2 and 3, the shape of the base 10 is similar to a wedge-like block, which has an inclined upper portion and a horizontal lower portion.

The base 10 is formed with a first inclined plane 11 on the first side 101. The first inclined plane 11 has a first end 111 and a second end 112, and the first end 111 is higher than the second end 112.

A first assembling section 12 is formed respectively protruding outward and sideward from the second and third sides 102 and 103 of the base 10. Further, the first assembling section 12 of the base 10 is formed with a first restriction plane 13 with respect to the first side 101. The first restriction plane 13 is inclined to be in correspondence with the first inclined plane 11. Each of the first restriction planes 13 has a first end 131 and a second end 132. The first restriction plane 13 is higher than the first inclined plane 11, thus each of the first assembling sections 12 of the base 10 is further formed with a first retainment plane 14 with respect to the third side 103 and adjacent to the first restriction plane 13. In order to prevent horizontal offsets or vertical displacements which may affect electrical connections during the skidding of the skid base 20, the third and fourth sides 203 and 204 of the skid base 20 are respectively retained by the mutually parallel first retainment planes 14 of the base 10 of the this embodiment, thereby limiting the skid base 20 from horizontal offsets during the skidding thereof.

Next, please refer to FIGS. 2, 4a and 4b. FIGS. 4a and 4b are perspective schematic views of the skid base from different viewpoints, respectively. The shape of the skid base 20 is similar to a wedge-like block, which has an inclined lower portion and a horizontal upper portion.

The skid base 20 is disposed on the base 10. The skid base 20 is formed with a second inclined plane 21 on the first side 201 opposing to the first inclined plane 11 of the base 10. Such second inclined plane 21 has a first end 211 and a second end 212, where the first end 211 is higher than the second end 212. The skid base 20 is disposed on the first inclined plane 11 of the base 10 via the second inclined plane 21 configured for skidding. In order to prevent horizontal offsets or vertical displacements which may affect electrical connections during the skidding of the skid base 20, the third and fourth sides 203 and 204 of the skid base 20 are respectively retained by the mutually parallel first retainment planes 14 of the base 10 of the this embodiment, thereby limiting the skid base 20 from horizontal offsets during the skidding thereof.

A second side 202 of the skid base 20 opposing to the second inclined plane 21 is formed with a load plane 22.

First ejecting blocks 23 are formed by respectively protruding sideward from the third and fourth sides 203 and 204 of the skid base 20 facing the first assembling sections 12. Such first ejecting blocks 23 are used for ejecting a strip 50. Each of the first ejecting blocks 23 has a first end 231 and a second end 232, where the first end 231 is higher than the second end 232. Further, the load plane 22 of the skid base 20 is formed with a plurality of second ejecting blocks 24 at an edge thereof opposite to the first end 211 of the second inclined plane 21, where the second ejecting blocks 24 are arranged with intervals. Such second ejecting blocks 24 are used for inserting the strip 50, and for guiding the electrodes 40 to be electrically connected to the strip 50.

Next, please refer to FIGS. 2, 5a and 5b. FIGS. 5a and 5b are perspective schematic views of the housing from different viewpoints. Each side of the housing is sheet-like, while the whole housing is U-shaped when viewing from a side thereof.

The housing 30 is provided above the skid base 20 and assembled with the base 10. The housing 30 is formed with a recess 31 on a first side 301 facing the load plane 22 of the skid base 20.

The housing 30 is bent on the second and third sides 302 and 303, respectively, accommodating the first assembling sections 12 of the base 10, so as to form second assembling sections 32. The second assembling sections 32 correspond to the shape of the first assembling sections 12 of the base 10, so the second and first assembling sections 32 and 12 are engaged in a manner of matching shapes. The abovementioned assembling method is only one of various assembling methods, but the present invention is not limited to the assembling method disclosed above.

Each of the second assembling sections 32 of the housing 30 is further formed with a second restriction plane 33. The second restriction planes 33 are inclined corresponding to the first inclined planes 11. Further, similar to the inclination with respect to the first side 201 at locations of the first ejecting blocks 23 corresponding to the first restriction planes 13, locations of the first ejecting blocks 23 corresponding to the second restriction planes 33 are also inclined with respect to the second side 202. Although a preferred embodiment has been disclosed above, the present invention is not limited thereto. Each of the second restriction planes 33 contains a first end 331 and a second end 332, where the first end 331 is higher than the second end 332.

The housing 30 is formed with a first insertion port 34 on the fourth side 304 adjacent to the second assembling sections 32. The first insertion port 34 corresponds to the load plane 22 of the skid base 20, enabling the strip 50 to be inserted through the first insertion port 34 and placed on the load plane 22.

The housing 30 is formed with a plurality of slots 35 on the first side 301 facing the load plane 22. The slots 35 are arranged with intervals in correspondence with the second ejecting blocks 24 of the skid base 20. The housing 30 is formed with a second insertion port 36 on the fifth side 305 with respect to the recess 31.

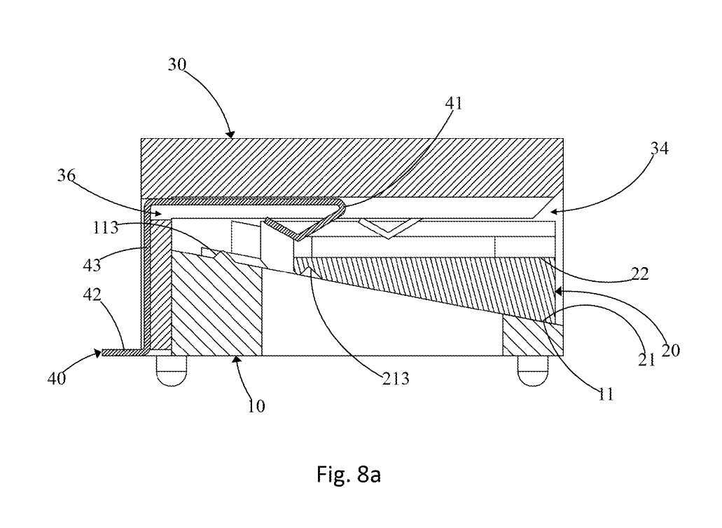

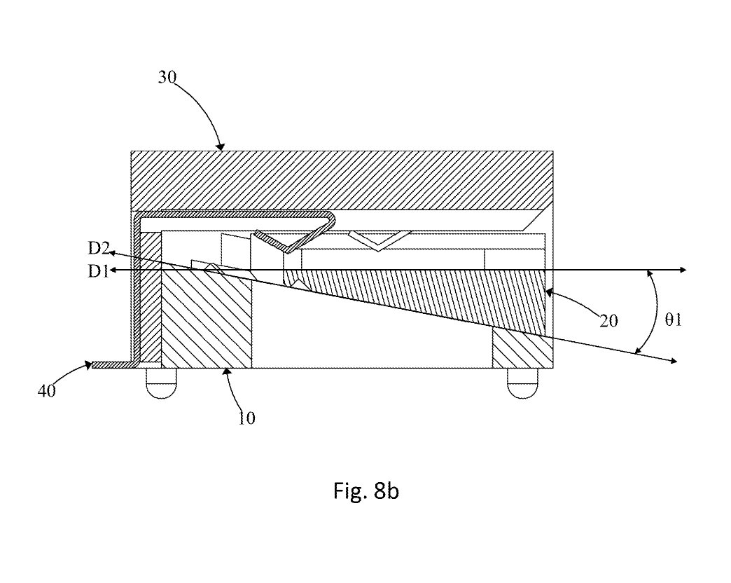

Continue referring to FIG. 2, and refer to FIG. 8a, which is cross-sectional view showing an assembly of the base 10, skid base 20, housing 30 and electrodes 40. The electrodes 40 are arranged with intervals and bent to form a first connecting end 41 and a second connecting end 42, respectively. Said first connecting ends 41 are inserted corresponding with the second insertion port 36 of the housing 30 and placed on the slots 35 in the recess 31 of the housing 30, allowing the first connecting ends 41 to be in electrical connection with the strip 50 corresponding to the first insertion port 34 of the housing 30. The first connecting ends 41 are different in length to match the electrical connecting positions of the strip 50. In addition, between the first and second connecting ends 41, 42 of the electrodes 40 are formed with the first retainment sections 43 which are disposed against the fifth side 305 of the housing 30. Thus, the second connecting ends 42 is adapted to be electrically connected to a biochemical testing machine if the electrical connector is disposed on the biochemical testing machine.

In the following, the inclined angle due to the height difference is further described with reference to the first inclined plane 11, second inclined plane 12, first ejecting blocks 23 and second restriction plane 33.

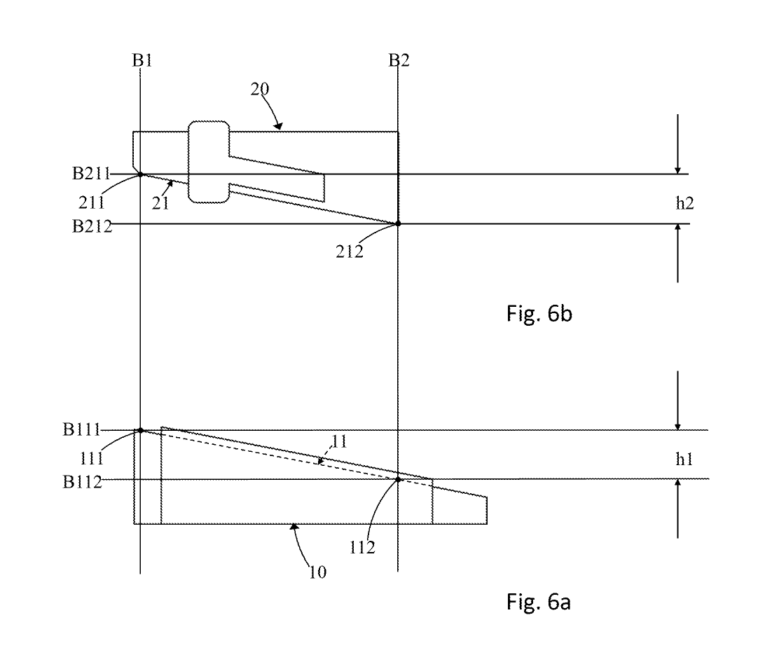

Please refer to FIG. 6a, which is a schematic plane view showing a first height difference h1 of the first inclined plane 11 of the base 10. A first lateral baseline B111 of the first end 111 intersecting a first longitudinal baseline B1 and a second lateral baseline B112 of the second end 112 intersecting a second longitudinal baseline B2 form the first height difference h1. Next, please refer to FIG. 6b, which is a schematic plane view showing a second height difference h2 of the second inclined plane 21 of the skid base 20. A third lateral baseline B211 of the first end 211 intersecting the first longitudinal baseline B1 and a fourth lateral baseline B212 of the second end 212 intersecting the second longitudinal baseline B2 form the second height difference h2. The first and second height differences h1 and h2 set forth in this embodiment are preferred aspects, but the present invention is not limited thereto. The skid base 20 may displace on the base 10 following the inclined angles caused by height differences.

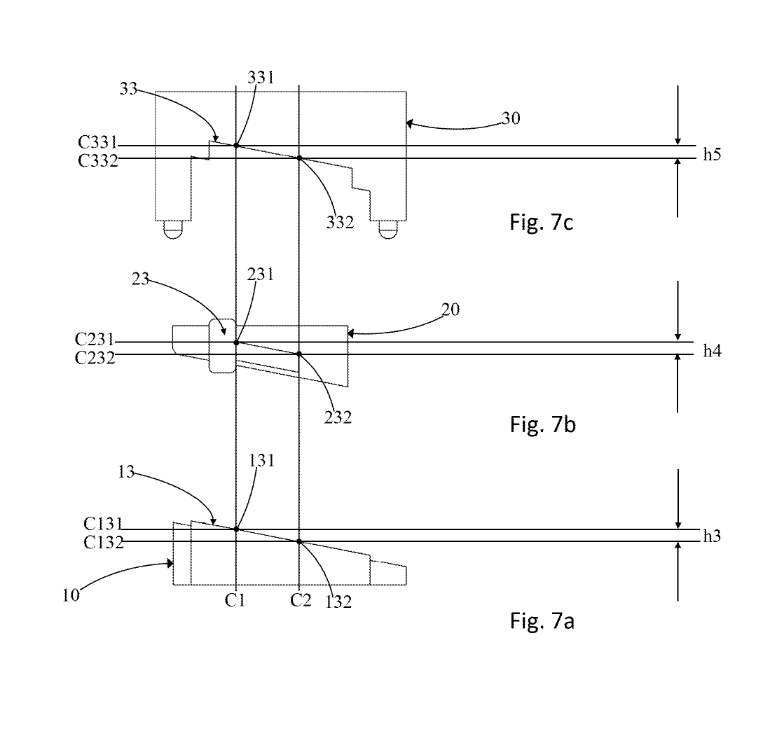

First see the base 10, please refer to FIG. 7a, which is a schematic plane view showing a third height difference h3 of the first restriction plane 13. A first lateral baseline C131 of the first end 131 intersecting a third longitudinal baseline C1 and a second lateral baseline C132 of the second end 132 intersecting a fourth longitudinal baseline C2 form the third height difference h3. Then see the skid base 20, please refer to FIG. 7b, which is a schematic plane view showing a fourth height difference h4 of the first ejecting blocks 23. A third lateral baseline C231 of the first end 231 intersecting the third longitudinal baseline C1 and a fourth lateral baseline C232 of the second end 232 intersecting the fourth longitudinal baseline C2 form the fourth height difference h4. Next see the housing 30, please refer to FIG. 7c, which is a schematic plane view showing a fifth height difference h5 of the second restriction plane 33. A fifth lateral baseline C331 of the first end 331 intersecting the third longitudinal baseline C1 and a sixth lateral baseline C332 of the second end 332 intersecting the fourth longitudinal baseline C2 form the fifth height difference h5. The third, fourth and fifth height differences h3, h4 and h5 set forth in this embodiment are preferred aspects, but the present invention is not limited thereto. With the first ejecting blocks 23 being securely retained by the first and second restriction planes 13 and 33, the skid base 20 may smoothly displace following the inclined angles caused by height differences with the help of the first ejecting blocks 23 and the first and second restriction planes 13 and 33.

In the following, a further description is made with reference to the base 10, skid base 20, housing 30 and electrodes 40.

Please refer to FIGS. 8a and 8b, which are cross-sectional views showing the assembly of the base, skid base, housing and electrodes and the first inclined angle thereof. The second assembling section 32 of the housing 30 is correspondingly assembled to the first assembling section 12 of the base 10, so that the skid base 20 is accommodated between the recess 31 of the housing 30 and the first inclined plane 11 of the base 10. Accordingly, the strip 50 will not be exposed to the outside of the electrical connector when being electrically connected to the electrodes 40. In addition, a first extension direction D1 of the load plane 22 of the skid base 20 and a second extension direction D2 of the first inclined plane 11 form a first inclined angle 81.

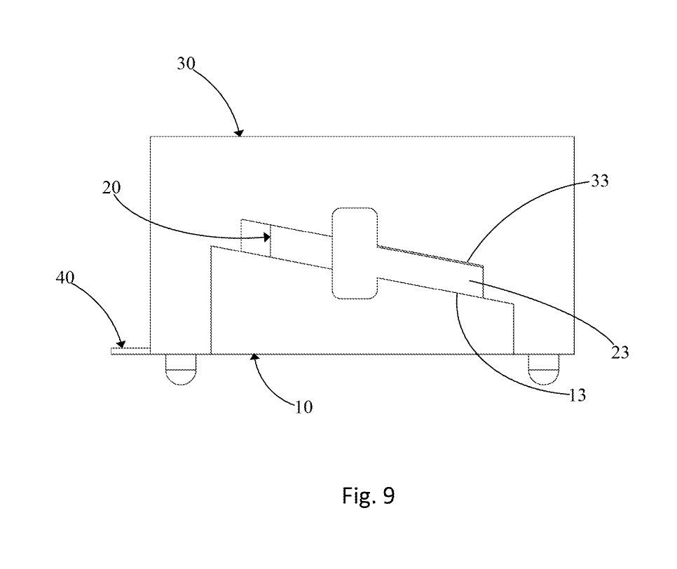

In case of the skid base 20, in order to prevent vertical displacements which may affect electrical connections during the skidding of the skid base 20, the second side 202 and first side 201 of the first ejecting blocks 23 of the skid base 20 are respectively retained by the second restriction plane 33 of the housing 30 and the first restriction plane 13 of the base 10 (please refer to FIG. 9, which is a side view showing the assembly of the base, skid base, housing and electrodes).

The second inclined plane 21 of skid base 20 is placed on the first inclined plane 11 of the base 10. When the skid base 20 is subjected to a force, it can skid on the base 10 due to the first inclined angle 81. Since friction exists between the first and second inclined planes 11 and 21 due to the materials thereof, external forces are required to make the skid base 20 skid. An external force can be produced by the strip 50 inserting into the electrical connector and pushing the skid base 20. As the external force is gone, the skid base 20 will stay still due to the friction between the skid base 20 and the base 10, thereby keeping the electrical connection of the strip 50 with the electrodes 40.

However, if the friction between the skid base 20 and the base 10 is not sufficient to keep the skid base 20 still, the first end 111 of the first inclined plane 11 of the base 10 can be further formed with a bump 113. In addition, the first end 211 of the second inclined plane 21 of the skid base 20 can be formed with a groove 213 corresponding to the bump 113. The bump 113 is adapted to be stuck and received in the groove 213 to help the skid base 20 to stay still on the base 10. Meanwhile, the strip 50 remains electrically connected to the electrodes 40.

In the following, the usage condition of the electrical connector with the strip 50 connected thereto is described.

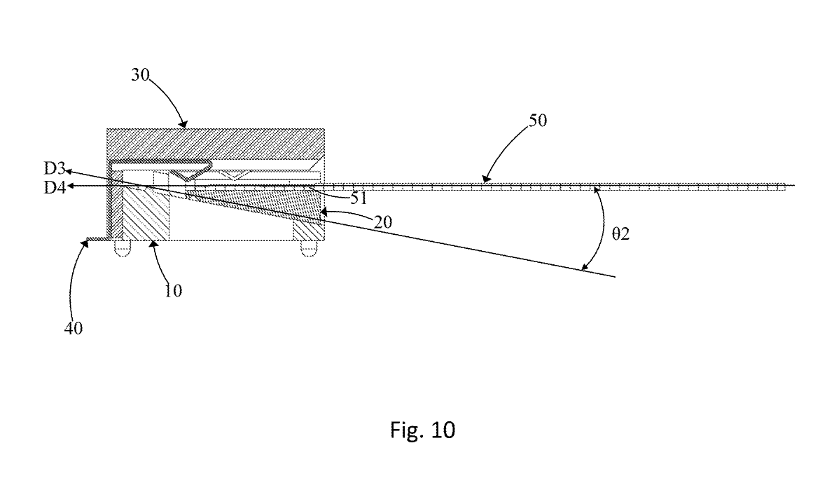

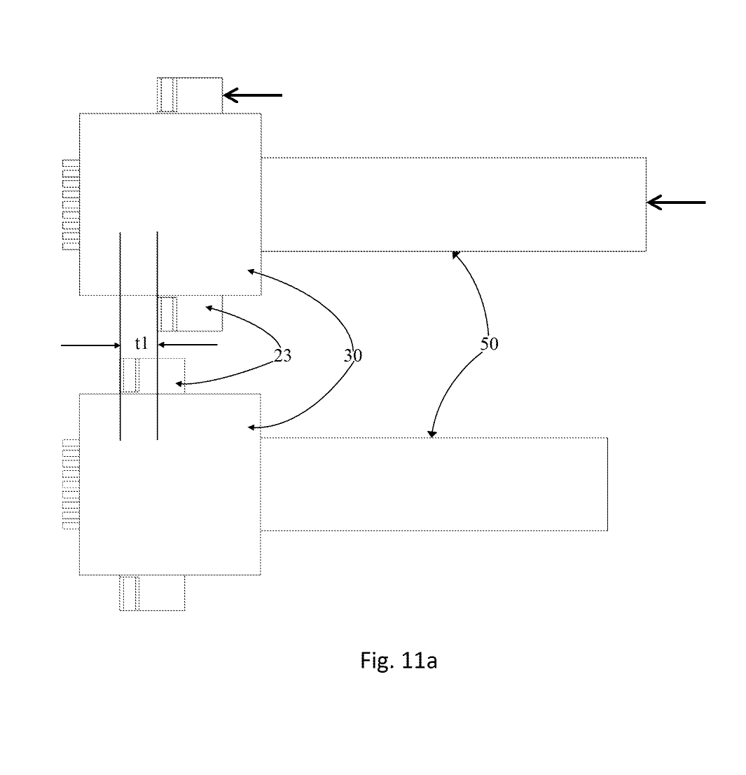

Please refer to FIG. 10, which is a cross-sectional view schematically showing an assembly of the base, skid base, housing, electrodes and strip and the second inclined angle thereof. The strip 50 is formed with an electrode end 51. The electrode end 51 of the strip 50 is inserted through the first insertion port 34 of the housing 30 along an insertion direction D3. The electrode end 51 is placed on the load plane 22 of the skid base 20 and will push the second ejecting blocks 24, so that the skid base 20 skids with respect to the base 10 along a displacement direction D4. The insertion direction D3 of the strip 50 and the displacement direction D4 of the skid base 20 form a second inclined angle θ2. The first and second inclined angles θ1 and θ2 are preferred aspects, but the present invention is not limited thereto.

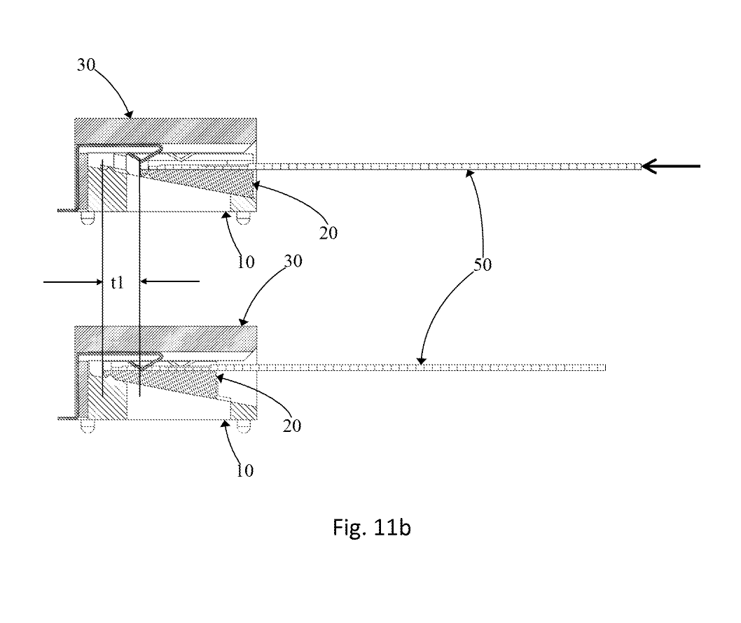

In order to restrict vertical displacements during the skidding of the skid base 20 and further restrict the skid distance t1 of the skid base 20, the second restriction plane 33 of the housing 30 and the first restriction planes 13 of the base 10 are respectively retained by the second side 202 and first side 201 of the first ejecting blocks 23 of the skid base 20. Please refer to FIGS. 11a and 11b, which respectively are top view and cross-sectional view schematically showing the strip 50 and the skid base 20. The upper parts of these two drawings illustrate the state of the electrical connector before the insertion of the strip, while the lower parts thereof illustrate the state of the electrical connector after the insertion of the strip, in which the skidding condition and skid distance t1 can be recognized.

The effects achieved by the aforementioned embodiments are analyzed as follows.

The second inclined plane 21 of the skid base 20 having an inclined angle and the first inclined plane 11 of base 10 having the inclined angle contact each other, so the strip 50 moves on the base 10 smoothly due to the first inclined angle θ1 of the skid base 20 caused by height difference. Therefore, scratch or damage can be reduced when the electrodes 40 contact with the strip 50, and the contact impedance of the electrical connector can be lowered, thereby improving the accuracy of tests.

The skid base 20 provides an ejecting mechanism for the electrical connector through the first ejecting blocks 23 together with the first and second restriction planes 13 and 33. Thus, after a test, the strip 50 can be ejected without using human hands, which reduces the possibility of contacting body fluids with human body.

After a test, the used strip 50 is ejected, wherein the retainment of the first ejecting blocks 23 by the first and second restriction planes 13 and 33 enables control of the force for ejecting the skid base 20, so that the risk of body fluid spattering and infection can be avoided.

For convenience of assembling and disassembling, the housing 30 and the second and first assembling section 32, 12 of the base 10 are detachably assembled.

The abovementioned are the preferred embodiments of the present invention and are not for limiting the present invention. The description above will be understood and implemented by those skilled in the art. Therefore, it is intended that equivalent alterations and modifications made without departing from the spirit disclosed by the present invention are included in the scope of the appended claims.

1. An electrical connector, comprising:
a base (10) having one side formed with a first inclined plane (11), the first inclined plane (11) having a first end (111) and a second end (112), the first end (111) being higher than the second end (112), a first assembling section (12) being formed on each side of the first inclined plane (11) of the base (10);
a skid base (20) being disposed on the base (10) and having a first side (201) facing the first inclined plane (11) formed with a second inclined plane (21), the second inclined plane (21) having a first end (211) and a second end (212), the first end (211) being higher than the second end (212), the second inclined plane (21) of the skid base (20) being slidably disposed on the first inclined plane (11) of the base (10), the skid base (20) having a second side (202) opposing the first side (201) formed with a load plane (22), the first inclined plane (11) extends at a first inclined angle (θ1) to the downside of the load plane (22);
a housing (30) disposed above the skid base (20) and assembled with the base (10), the housing (30) having a first side (301) facing the load plane (22) of the skid base (20) formed with a recess (31), the skid base (20) being accommodated between the recess (31) of the housing (30) and the first inclined plane (11) of the base (10), a second assembling section (32) being formed on each side of the housing (30) to be correspondingly assembled with the first assembling section (12), the second assembling section (32) of the housing (30) and the first assembling section (12) of the base (10) being joined correspondingly, the housing (30) having a side adjacent to the second assembling section (32) formed with a first insertion port (34); and
a plurality of electrodes (40) inserted through an another side adjacent to the second assembling section (32) of the housing (30), and disposed on the recess (31) of the housing (30) to be opposite to the first insertion port (34) of the housing (30).

2. The electrical connector of claim 1, wherein:
the first assembling section (12) of the base (10) is further formed with a first restriction plane (13) having a first end (131) and a second end (132), the first end (131) being higher than the second end (132);
a first ejecting block (23) having a first end (231) and a second end (232) is formed on each side of the skid base (20) to face the first assembling section (12) with the first end (231) being higher than the second end (232); and
the second assembling section (32) of the housing (30) is further formed with a second restriction plane (33) having a first end (331) and a second end (332) with the first end (331) being higher than the second end (332),
the second restriction plane (33) of the housing (30) and the first restriction plane (13) of the base (10) together restrict a skidding distance of the first ejecting block (23) of the skid base (20).

3. The electrical connector of claim 1, wherein:
the load plane (22) of the skid base (20) is further formed with a plurality of second ejecting blocks (24) at an edge being opposite to the first end (211) of the second inclined plane (21);
the housing (30) is provided with a plurality of slots (35) on the recess (31), and the housing (30) is formed with a second insertion port (36) on the other side adjacent to the second assembling section (32); and
the electrodes (40) are inserted through the second insertion port (36) and respectively disposed onto the slots (35) of the recess (31).

4. The electrical connector of claim wherein:
a bump (113) is formed on the first end (111) of the first inclined plane (11) of the base (10); and
a groove (213) is formed on the first end (211) of the second inclined plane (21) of the skid base (20) to be opposite to the bump (113).

5. An electrical connector inserted with a strip, comprising:
a strip (50) having an electrode end (51); and
at least one of the electrical connectors of claim 1, the electrode end (51) of the strip (50) being inserted through the first insertion port (34) of the housing (30) along an insertion direction, the electrode end (51) being placed on the load plane (22) of the skid base (20), the skid base (20) being pushed by the electrode end (51) to skid on the base (10) along a displacement direction, the insertion direction and the displacement direction including a second inclined angle (θ2); wherein the second inclined angle (θ2) is equal to the first inclined angle (θ1).
